(19) United States
(12) Patent Application Publication
(10) Pub. No.: US 2007/0238615 A1
(43) Pub. Date: Oct. 11, 2007

(54) Liquid Formulations in Crop Protection and Their Use

(75) Inventors: Hans-Peter Krause, Hofheim (DE); Gerhard Schnabel, Elsenfeld (DE); Roland Deckwer, Frankfurt (DE); Udo Bickers, Wietmarschen (DE)

Correspondence Address: FROMMER LAWRENCE & HAUG, 745 FIFTH AVENUE- 10TH FL., NEW YORK, NY, 10151, US

(73) Assignee: Bayer CropScience GmbH, Frankfurt (DE)

(21) Appl. No.: 11/695,382

(22) Filed: Apr. 2, 2007

(30) Foreign Application Priority Data
Apr. 5, 2006 (DE) 10 2006 015 940.3

(51) Int. Cl. A01N 25/26; A01N 25/32

(52) U.S. Cl. 504/100; 504/103; 504/104

(57) ABSTRACT

Liquid formulations in crop protection and their use Formulations with delayed release of agrochemical actives from the group of fatty acid synthetase inhibitors are suitable for reducing phytotoxicity in crop plants when said agrochemical actives are used to check unwanted detrimental organisms in the crops.

The present invention pertains to the technical field of the formulation of crop protection agents, more particularly of herbicidal actives from the group of fatty acid synthetase inhibitors, and especially the inhibitors of acetyl-coenzyme A carboxylase (ACCase inhibitors).

Formulations of fatty acid synthetase inhibitors, especially of ACCase inhibitors, are well known to the artisan. Thus there are for example actives for controlling unwanted plant growth, more particularly actives (graminicides) for controlling grasses in monocot and dicot crops, that come from the group of the ACCase inhibitors. Examples of ACCase inhibitors are herbicides from the group of phenoxyphenoxy- and heteroaryloxyphenoxy-propionic acids and their esters and salts, and from the group of cylcohexanedione oximes; cf. “The Pesticide Manual”, British Crop Protection Council, 13th edition, 2004/2005.

Herbicidal graminicide formulations are well described in the literature and widely available commercially as products. Nevertheless the known formulations are not suitable for all desired applications or exhibit technical problems which cannot be solved with conventional formulations. For example, a frequent consequence of the application of highly effective fatty acid synthetase inhibitors, as for example of ACCase inhibitors, for controlling weeds in crops is phytotoxic damage to the crop plants, in crops such as rice, wheat or barley, for example.

It is an object of the present invention to reduce or prevent the incidence of damage to crop plants when particular herbicides are applied.

Surprisingly it has now been found that this problem can be solved by a particular formulation technology.

The invention provides the use of a delayed-release formulation (controlled release formulation), preferably a formulation with microencapsulation of agrochemical actives, preferably herbicidal actives, from the group of fatty acid synthetase inhibitors, especially of ACCase inhibitors, for reducing phytotoxicity in crop plants when said agrochemical actives are used to check unwanted detrimental organisms, such as weeds, insects or fungi, in crops of said crop plants.

The checking of detrimental organisms, particularly of weeds, means the control of detrimental organisms, where a reduction is achieved in the detrimental organisms that is brought about causally by the application of the actives. The extent of the reduction in the detrimental organisms depends on the specific case: generally speaking, on the respective active or combinations of actives, on the application rate, the crop plants, the infestation by detrimental organisms, the spectrum of detrimental organisms, the time of application (e.g., pre- and post-emergence application), the soil and weather conditions, the nature of microencapsulation.

Preference is given to the inventive use with a checking of the detrimental organisms that permits an economically acceptable tradeoff between input and yield.

Preference is also given to an inventive use which allows an activity of 50% to 100%, preferably 70% to 100%, against one or more economically important detrimental organisms in comparison to the untreated crop and at the same time allows a reduction in the phytotoxicity to the crop plant to be observed.

Further preference is given to the inventive use wherein the desired efficacy of the agrochemical actives against one or more types of detrimental organisms, such as one or more types of weeds, for a given application rate of the active is increased or is not or not substantially impaired. Impairment is considered not substantial if the efficacy is reduced at most by 10%, preferably by not more than 5%, as compared with a standard formulation—in other words, without the use of a controlled release formulation or of the formulation with microencapsulated active.

Preference is given to the inventive use where the agrochemical active is applied in a controlled-release formulation, more particularly in microencapsulated form, to the plants, parts of plants, their seed or the cultivation area.

WO-A-01/84928 has already disclosed the application of certain microencapsulated actives, including for example microencapsulated ACCase inhibitors such as fenoxaprop-P ethyl, in combination with at least one other active for the purpose of suppressing antagonistic effects of the two actives. The encapsulated actives are in that case formulated as, for example, capsule suspensions.

There had been no disclosure to date that through microencapsulation it is possible to improve the crop plant tolerance of actives from the group of fatty acid synthetase inhibitors. This effect is particularly surprising when it is borne in mind that the microencapsulation generally does not impair, and in known cases, indeed, actually boosts, the activity with respect to the detrimental organisms.

Where the controlled release formulations of the agrochemical actives from the group of fatty acid synthetase inhibitors, more particularly ACCase inhibitors, are still new, they are likewise provided by the invention.

The controlled release formulations suitable for the inventive use can be produced by conventional methods.

Preferred formulations with microcapsules (capsule suspensions) are those containing
0.3 to 60 weight percent (i.e., % by weight) of one or more actives from the group of fatty acid synthetase inhibitors, more particularly ACCase inhibitors, wholly or partly microencapsulated, preferably microencapsulated with a fraction of more than 50%,
5% to 80%, preferably 5% to 60%, in particular 10% to 60% by weight of organic solvents or solvent mixtures,
5% to 80%, preferably 10% to 60%, in particular 20% to 50% by weight of water,
0% to 30%, preferably 2% to 30%, in particular 2% to 20% by weight of one or more aromatic or nonaromatic surfactants,
0% to 30%, preferably 0.5% to 30%, in particular 0.5% to 20%, especially 2% to 15% by weight of one or more dispersants for physical stabilization,
0% to 50%, preferably 0% to 30% by weight of further agrochemical actives, and
0% to 30%, preferably 2% to 20% by weight of further formulating auxiliaries.

Suitable actives for microencapsulation are for example fatty acid synthetase inhibitors, more particularly ACCase inhibitors such as for example
phenoxyphenoxy- and (heteroaryloxyphenoxy)-alkanecarboxylic acids and their esters and salts, such as fenoxaprop-P-ethyl, diclofop-methyl, clodinafop-propargyl, cyhalofop-butyl, fluazifop-P-butyl, haloxyfop and haloxyfop esters, metamifop, propaquizafop, quizalofop-P esters and also fenoxaprop-ethyl, diclofop-P-methyl, haloxyfop-P, haloxyfop-P-methyl, quizalofop, quizalofop-ethyl, quizalofop-P, quizalofop-P-ethyl, quizalofop-P-tefuryl, and metamifop, preferably the esters of (heteroaryloxyphenyl)propionic acids,
cyclohexanedione oximes (“dims”), such as cycloxydim, clethodim, butroxydim, alloxydim, profoxydim, sethoxydim, tepraloxydim, and tralkoxydim,
ketoenols with herbicidal, fungicidal or insecticidal activity (substituted cyclic ketoenols), preferably with herbicidal activity, examples being pinoxaden and those as are known, inter alia, from WO-A-03/13249, WO-A-03/029213, WO-A-2004/037749, WO-A-2004/069841, WO-A-2005/016933, and in each case literature cited therein.

Preferred formulations are those which include fenoxaprop-P-ethyl, clodinafop-propargyl, quizalofop-P esters, clethodim or herbicidal ketoenols.

Also suitable are coformulations of two or more of the stated actives, examples being coformulations including the following binary active combinations:

fenoxaprop-(P)-ethyl+diclofop-methyl, diclofop-P-methyl or clodinafop-propargyl or cyhalofop-butyl or fluazifop-P-butyl or haloxyfop or haloxyfop-methyl or haloxyfop-P or haloxyfop-P-methyl or metamifop or propaquizafop or quizalofop or quizalofop-P or quizalofop-ethyl or quizalofop-P-ethyl or quizalofop-P-tefuryl or cycloxydim or clethodim or butroxydim or alloxydim or profoxydim or sethoxydim or tepraloxydim or tralkoxydim or pinoxaden, “fenoxaprop-(P)-ethyl” standing for “fenoxaprop-ethyl or fenoxaprop-P-ethyl”;

diclofop-(P)-methyl+clodinafop-propargyl or cyhalofop-butyl or fluazifop-P-butyl or haloxyfop or haloxyfop-methyl or haloxyfop-P or haloxyfop-P-methyl or metamifop or propaquizafop or quizalofop or quizalofop-P or quizalofop-ethyl or quizalofop-P-ethyl or quizalofop-P-tefuryl or cycloxydim or clethodim or butroxydim or alloxydim or profoxydim or sethoxydim or tepraloxydim or tralkoxydim or pinoxaden, “diclofop-(P)-methyl” standing for “diclofop-methyl or diclofop-P-methyl”;

clodinafop-propargyl+cyhalofop-butyl or fluazifop-P-butyl or haloxyfop or haloxyfop-methyl or haloxyfop-P or haloxyfop-P-methyl or metamifop or propaquizafop or quizalofop or quizalofop-P or quizalofop-ethyl or quizalofop-P-ethyl or quizalofop-P-tefuryl or cycloxydim or clethodim or butroxydim or alloxydim or profoxydim or sethoxydim or tepraloxydim or tralkoxydim or pinoxaden;

cyhalofop-butyl+fluazifop-P-butyl or haloxyfop or haloxyfop-methyl or haloxyfop-P or haloxyfop-P-methyl or metamifop or propaquizafop or quizalofop or quizalofop-P or quizalofop-ethyl or quizalofop-P-ethyl or quizalofop-P-tefuryl or cycloxydim or clethodim or butroxydim or alloxydim or profoxydim or sethoxydim or tepraloxydim or tralkoxydim or pinoxaden;

fluazifop-P-butyl+haloxyfop or haloxyfop-methyl or haloxyfop-P or haloxyfop-P-methyl or metamifop or propaquizafop or quizalofop or quizalofop-P or quizalofop-ethyl or quizalofop-P-ethyl or quizalofop-P-tefuryl or cycloxydim or clethodim or butroxydim or alloxydim or profoxydim or sethoxydim or tepraloxydim or tralkoxydim or pinoxaden;

haloxyfop(-P)(methyl)+metamifop or propaquizafop or quizalofop or quizalofop-P or quizalofop-ethyl or quizalofop-P-ethyl or quizalofop-P-tefuryl or cycloxydim or clethodim or butroxydim or alloxydim or profoxydim or sethoxydim or tepraloxydim or tralkoxydim or pinoxaden, “haloxyfop(-P)(methyl)” standing for “haloxyfop or haloxyfop-P or haloxyfop-methyl or haloxyfop-P-methyl”;

metamifop+propaquizafop or quizalofop or quizalofop-ethyl or quizalofop-P or quizalofop-P-ethyl or quizalofop-P-tefuryl or cycloxydim or clethodim or butroxydim or alloxydim or profoxydim or sethoxydim or tepraloxydim or tralkoxydim or pinoxaden;

propaquizafop+quizalofop or quizalofop-ethyl or quizalofop-P or quizalofop-P-ethyl or quizalofop-P-tefuryl or cycloxydim or clethodim or butroxydim or alloxydim or profoxydim or sethoxydim or tepraloxydim or tralkoxydim or pinoxaden;

quizalofop(-P)(ethyl/tefuryl)+cycloxydim or clethodim or butroxydim or alloxydim or profoxydim or sethoxydim or tepraloxydim or tralkoxydim or pinoxaden, “quizalofop(-P)(ethyl/tefuryl)” standing for “quizalofop or quizalofop-P or quizalofop-ethyl or quizalofop-P-ethyl or quizalofop-tefuryl or quizalofop-P-tefuryl”;

cycloxydim+clethodim or butroxydim or alloxydim or profoxydim or sethoxydim or tepraloxydim or tralkoxydim or pinoxaden;

clethodim+butroxydim or alloxydim or profoxydim or sethoxydim or tepraloxydim or tralkoxydim or pinoxaden;

butroxydim+alloxydim or profoxydim or sethoxydim or tepraloxydim or tralkoxydim or pinoxaden;

alloxydim+profoxydim or sethoxydim or tepraloxydim or tralkoxydim or pinoxaden;

profoxydim+sethoxydim or tepraloxydim or tralkoxydim or pinoxaden;

sethoxydim+tepraloxydim or tralkoxydim or pinoxaden;

tepraloxydim+tralkoxydim or pinoxaden;

tralkoxydim+pinoxaden.

Preference is also given to coformulations of two or more of the stated actives, such as

fenoxaprop-P-ethyl+clodinafop-propargyl,

fenoxaprop-P-ethyl+clethodim or

fenoxaprop-P-ethyl+diclofop-methyl.

Generally speaking the actives are located in the organic phase (“oil phase”), which is wholly or partly microencapsulated.

The active (e.g., ACCase inhibitor) is present for example within the formulation in largely encapsulated form, i.e., with a more than 95% by weight fraction of the overall active content; it is also possible for one or more actives (e.g., ACCase inhibitors) to be wholly or partly microencapsulated. The active or mixture of actives is present preferably with a fraction of more than 50% by weight of the overall active content of the formulation in microencapsulated form.

To produce the controlled release formulations, the respective agrochemical active is incorporated for example into suitable carrier materials, which are organic or inorganic in origin. These carrier materials surround the actives in such a way that they are unable to emerge directly into the ambient environment. The actives are separated physically from the environment and from the other active or actives. Only by means of particular mechanisms, such as breakdown of the carrier material, bursting of the carrier surrounding the active, or outward diffusion, is the active released.

The agrochemical active from the group of fatty acid synthetase inhibitors that is to be incorporated wholly or partly into the carrier is an active which at an appropriate dosage induces a phytotoxic activity in crop plants.

Two or more actives in a mixture of actives may also be incorporated in one carrier.

The incorporation of actives into carrier materials for the purpose of providing formulations which permit controlled release is a known principle and can be found in the technical literature. Examples are found in C. L. Foy, D. W. Pritchard, “Pesticide Formulation and Technology”, CRC Press, 1996, page 273 ff and literature cited therein, and D. A. Knowles, “Chemistry and Technology of Agrochemical Formulations”, Kluwer Academic Press, 1998, page 132 ff. and literature cited therein.

The carrier materials which surround or envelope the actives are chosen such that they are solid within a suitable temperature range, preferably in the range of approximately 0-50° C. By solid materials in this context are meant materials which are hard, waxily elastic, amorphous or crystalline, but are not, or not at this point, in the liquid aggregate state. The carrier materials may be organic or inorganic in nature and synthetic or natural in origin.

One means of incorporating the agrochemical actives into suitable carrier materials is that, for example, of microencapsulation. The microcapsules may be composed of polymeric materials of synthetic and/or natural origin. Examples of suitable materials include polyureas, polyurethanes, polyamides, melamine resins, gelatin, wax, and polysaccharides and their derivatives such as starch or cellulose.

Microcapsules of some of these materials can be prepared, for example, by the method of interfacial polycondensation. Via the amount of monomers, amount of active, amount of water and solvent, and also operation of parameters it is possible to exert effective control over particle size and wall thickness and hence also over the release rates.

In the case of microcapsules formed from polyurethane or polyureas, the most common way of building up the stated capsule wall around the active that is to be enveloped is that of boundary phase polymerization in oil-in-water emulsions, the organic phase containing not only the active but also an oil-soluble prepolymer containing free isocyanate groups.

Suitable prepolymers include the typical isocyanates known to the artisan, based for example on 2,4-tolylene diisocyanate, 2,6-tolylene diisocyanate, 4,4′-methylenedi(phenyl isocyanate), hexamethylene diisocyanate or TMXDI [i.e., α,α,α′α′-tetramethyl-m-xylylene diisocyanate is 1,3-bis(1-isocyanato-1-methylethyl)benzene].

The polymerization, in other words the construction of the shell of the microcapsules, is generally carried out in accordance with the typical methods known to the artisan.

The capsule-forming material from which the shells of the microcapsules are constructed is preferably obtained starting from oil-soluble isocyanate-functional prepolymers, which are a group of technical mixture products composed in each case of polyisocyanates based on condensates of aniline and formaldehyde. These technical mixture products differ from one another in their degrees of condensation and, where appropriate, in chemical modifications. Important characteristics for the user are viscosity and free isocyanate group content. Typical commercial products here are Desmodur® products (Bayer AG) and Voranate® products (Dow Chemicals).

For the formulations of the invention the amount of isocyanate group prepolymer used is preferably up to 5% by weight, based on the overall formulation; further preferred are formulations with 0.5% to 5%, in particular 1% to 3%, especially 1% to 2% by weight of prepolymer used, based on the weight of the overall formulation.

The capsule-forming material is formed by curing of the isocyanate prepolymer either in the presence of water at 0-95° C., preferably 20-65° C., or, preferably, with the requisite amount of a diamine or polyamine.

Where the microcapsules are prepared by heating in the presence of water (“hot encapsulation”) the capsule material is virtually 100% composed of the prepolymer employed.

Where the microcapsules are formed with incorporation of diamines or polyamines, examples of suitable such amines include alkylenediamines, dialkylenetriamines and trialkylenetetramines whose carbon chain units contain 2 to 20, preferably 2 to 8, carbon atoms. The alkylene group or the hydrocarbon fraction of the polyamines may be linear, branched, cyclic, saturated, unsaturated or, especially, aromatic. Additionally, instead of the pure hydrocarbon moieties and alkylene groups with a carbon backbone, suitability is also possessed by those diamines or polyamines which instead of a hydrocarbon moiety contain one or more heteroatoms in the carbon backbone, preferably from the group O, S and N (the latter present as N triply substituted by C atoms or as NH), especially O. This also includes backbones with heterocyclic or, especially, heteroaromatic moieties. Also suitable in general are diamines or polyamines in which the stated nuclear frameworks have further substituents—for example, in addition to alkyl, cycloalkyl, alkenyl, and alkynyl groups, also functional groups such as alkoxy, alkylthio, halogen, nitro, cyano, acyloxy, and dialkylamino, or else acyl group such as alkoxycarbonyl and alkylcarbonyl. A preferred diamine is hexamethylenediamine. In this context it is possible either to use amounts which are in stoichiometric proportion to the amount of isocyanate prepolymer used or, preferably, to use an excess of up to three times, in particular up to two times.

The literature contains further methods of producing microcapsules from polyurethanes or polyurea that are likewise suitable for producing the microcapsules of the invention. These methods are set out hereinbelow.

U.S. Pat. No. 3,577,515 describes how, following addition of water-soluble polyamines, the droplet surface in such emulsions cures as a result of addition reaction with the prepolymers containing isocyanate groups. In the course of this reaction an outer polyurea shell is formed.

From U.S. Pat. No. 4,140,516 it is known that even without external water-soluble amines it is possible to obtain microcapsules with a polyurea-type outer skin by allowing partial hydrolysis of the isocyanate-functional prepolymer in the emulsion. In the course of this partial hydrolysis, some of the amino groups are reformed from the isocyanate groups, and internal polyaddition with subsequent curing results likewise in the desired capsule shell. The use is described of tolylene diisocyanate, hexamethylene diisocyanate, methylenediphenyl diisocyanate and its higher homologs. If curing is to take place with an external polyamine, said polyamine originates usually from the group consisting of ethylenediamine, propylenediamine, hexamethylenediamine, diethylenetriamine, and tetraethylenepentamine. Preference is given in this context to 1,2-ethylenediamine, 1,2-propylenediamine, 1,3-propylenediamine, and 1,6-hexamethylenediamine.

DE-A-2 757 017 discloses internally structured microcapsules whose wall material has the nature of a mixed polymer which is crosslinked through urea groups and urethane groups. In the interior of the capsule the active is located in solution in an organic solvent. Typically here, based on the overall formulation, 10% of prepolymer is required for the construction of the capsule wall.

The same prepolymer is also used in accordance with WO-A-96/09760 for the encapsulation of, for example, endosulfan.

WO-A-95/23506 discloses endosulfan-loaded polyurea microcapsules in which the active is in the form of a cooled melt. As the prepolymer, a description is given of a mixture of methylenediphenyl diisocyanate and its higher homologs; the amount of prepolymer used, based on the overall formulation, is above 6%. Curing takes place with a mixture of polyamines.

With respect to the materials of the microcapsule wall and the production processes, the content of the patents and patent applications recited above is an important and integral part of the present invention and is incorporated by reference into the present specification.

A further means of encapsulation is that of capsule formation from melamine/formaldehyde or urea/formaldehyde, for example.

For this purpose melamine or the abovementioned isocyanate prepolymers is or are initially introduced in water, and the water-insoluble active is added. Said active has beforehand been dispersed or has been dissolved and emulsified in a water-soluble solvent. As a result of the setting of an acidic pH of approximately 3-4, preferably approximately 3-5, and of several hours of stirring at an elevated temperature of between 30 and 60° C., preferably 50° C., the capsule wall is formed by polycondensation. Examples of this are described in U.S. Pat. No. 4,157,983 and U.S. Pat. No. 3,594,328, whose content in relation to the production of capsules is incorporated by reference into the present specification.

A further suitable method for the microencapsulation of the agrochemical actives is that of coacervation. For this purpose the water-insoluble agrochemical active is dispersed in water and an anionic, water-soluble polymer and a cationic material are added. The microcapsules which form by a process referred to as coacervation, with the originally water-soluble polymer as their wall material, are insoluble in water. In the final step, then, the capsule is cured by condensation reaction with aldehydes. An example of a suitable combination for this purpose is that of gelatin/gum Arabic (1:1) and formaldehyde. The process of microencapsulation by coacervation is known to the artisan. The method is described exhaustively by, for example, J. A. Bahan, “Microencapsulation using Coacervation/Phase Separation Techniques, Controlled Released Technology: Methods, Theory and Application”, Vol. 2, Kydoniens, A. F., Ed., CRC Press, Inc., Boca Raton, Fla. 1980, Chapter 4.

Finally it is possible for the purpose of microencapsulation, for example, to emulsify the active and the polymer that forms the capsule wall in water using a suitable surfactant. In this case, polymer and active should not dissolve in one another. The solvent is then evaporated with stirring. When the water is removed the polymer forms a coat around the surface of the emulsified droplet.

Another suitable material for producing microcapsules or other controlled release formulations is wax. For this purpose, self-emulsifying waxes either are dissolved in water with heating and shearing, or are converted into an emulsion by addition of surfactants with heating and shearing. Lipophilic agrochemical actives dissolve in the melted and emulsified wax. The droplets solidify in the course of cooling, thereby forming the wax dispersion.

Alternatively it is possible to produce wax dispersions by dispersing extruded active/wax granules in water or oil and subjecting the dispersions to fine grinding, to give particles sizes, for example, of less than 20 μm.

Examples of suitable waxes include PEG 6000 in a mixture with nonhydrophilic waxes, Synchrowachs HGLC1, Mostermont® CAV2, Hoechst-Wachs OP3 or combinations of these waxes.

An aqueous dispersion of the particles (microcapsules or wax particles) can be obtained similarly to the formulas for a CS formulation (capsule suspension).

The microcapsules obtained in accordance with the methods described above can also be incorporated into different formulations mentioned in the text below. In that case it is also possible for further actives and/or agrochemical products such as adjuvants or fertilizers, for example, to be incorporated into the formulation: for example, water-soluble actives in the aqueous phase of the capsule dispersion, or solid actives in WG formulations, for example.

After microencapsulation has taken place, the capsules can be freed from the solvent and dried by the typical methods, as for example by spray drying.

The capsules can be stored and dispatched in this form and prior to application to the crop in question are formulated with any additional actives, adjuvants, and the typical additives.

The dispersion obtained after the curing of the capsules, however, can also be used for producing suitable agrochemical formulations comprising the abovementioned further constituents, without the capsules being isolated from the dispersions. Also possible besides this is the production of liquid coformulations.

In these microcapsule dispersions it is possible to use organic solvents or their mixtures from the group consisting of N-alkyl-fatty acid amides, N-alkyl lactams, fatty acid esters, cyclohexanones, isophorones, phthalic esters, and aromatic hydrocarbons, particular suitability being possessed by lower alkyl-substituted naphthalene derivatives.

Solvents suitable in accordance with the invention for the microcapsule formulations are for example apolar solvents, polar protic solvents or aprotic dipolar solvents and mixtures thereof. Examples of organic solvents for the purposes of the invention are
aliphatic or aromatic hydrocarbons, such as mineral oils, paraffins or toluene, xylenes and naphthalene derivatives, especially 1-methylnaphthalene, 2-methylnaphthalene, C₆-C₁₆ aromatics mixtures such as the Solvesso® series (ESSO) with the products Solvesso® 100 (b.p. 162-177° C.), Solvesso® 150 (b.p. 187-207° C.), and Solvesso® 200 (b.p. 219-282° C.), for example, and 6-20C aliphatics, which may be linear or cyclic, such as the products of the Shellsol® series, products T and K, or BP-n paraffins,
halogenated aliphatic or aromatic hydrocarbons such as methylene chloride and chlorobenzene,
monobasic and polybasic esters such as triacetin (acetic triglyceride), butyrolactone, propylene carbonate, triethyl citrate and C₁-C₂₂ alkyl phthalates, especially C₄-C₈ alkyl phthalates,
ethers such as alkylene glycol monoalkyl and dialkyl ethers such as, for example, propylene glycol monomethyl ether, especially Dowanol® PM (propylene glycol monomethyl ether), propylene glycol monoethyl ether, ethylene glycol monomethyl ether or monoethyl ether, diglyme and tetraglyme,
ketones, examples being water-immiscible ketones such as cyclohexanone or isophorone,
oils of natural origin, examples being vegetable oils such as corn germ oil and rapeseed oil and their transesterification products such as rapeseed oil methyl ester.

Commercially available solvents particularly suitable in accordance with the invention are, for example, Solvesso® 200, Solvesso® 150, and Solvesso® 100 (1), Solvesso® 200 ND* (1a), Solvesso® 150 ND* (1b), butyl diglycol acetate, Shellsol® RA (2), Acetrel® 400 (3), Agsolex® 8 (4), Agsolex® 12 (5), Norpar® 13 (6), Norpar® 15 (7), Isopar® V (8), Exsol® D 100 (9), Shellsol® K (10), and Shellsol® R (11), the compositions of which are as follows:
(1) Aromatics mixtures; manufacturer: Exxon, the designation ND* in case (1a) or (1b) denoting a purity level in relation to the fraction of naphthalene (ND*=‘naphthalene depleted’=less than 1% naphthalene).
(2) Mixtures of alkylated benzenes, boiling range 183-312° C., manufacturer: Shell.
(3) High-boiling aromatics mixture, boiling range 332-355° C., manufacturer: Exxon.
(4) N-Octylpyrrolidone, boiling point (0.3 mmHg) 100° C., manufacturer: GAF.
(5) N-Dodecylpyrrolidone, boiling point (0.3 mmHg) 145° C., manufacturer: GAF.
(6) Aliphatic hydrocarbons, boiling range 228-243° C., manufacturer: Exxon.
(7) Aliphatic hydrocarbons, boiling range 252-272° C., manufacturer: Exxon.
(8) Aliphatic hydrocarbons, boiling range 278-305° C., manufacturer: Exxon.
(9) Aliphatic hydrocarbons, boiling range 233-263° C., manufacturer: Exxon.
(10) Aliphatic hydrocarbons, boiling range 192-254° C., manufacturer: Shell.
(11) Aliphatic hydrocarbons, boiling range 203-267° C., manufacturer: Shell.
(12) Oils, for example of natural origin, examples being vegetable oils such as corn germ oil or rapeseed oil and their derivatives, such as rapeseed oil methyl ester, for example.

Mixtures of these solvents with one another are also suitable. In particular, butyl diglycol acetate, Acetrel® 400, Agsolex® 8, and Agsolex® 12 are very useful. Solvesso® 200 is particularly preferred.

The surfactants are for example one or more aromatic surfactants (i.e., aromatic carbocyclic or heteroaromatic surfactants) or nonaromatic surfactants. They act preferably as wetters, emulsifiers, spreaders, uptake enhancers or retention promoters and where appropriate also act in combination with other components present in the formulation, such as solvents, for example.

The aqueous phase of the dispersions of the invention comprises, where appropriate, surface-active formulating auxiliaries from the group of the emulsifiers, dispersants, wetters, spreaders, etc. A strict division of surfactants into emulsifiers, dispersants, wetters, and spreaders, or adjuvants, such as retention promoters or penetration promoters, is generally not possible, since surfactants are often multifunctional.

Surfactants are, for example, nonaromatic-based surfactants, based for example on heterocycles, olefins, aliphatics or cycloaliphatics, examples being surface-active, mono-or poly-alkyl-substituted and subsequently derivatized, e.g., alkoxylated, sulfated, sulfonated or phosphated, pyridine, pyrimidine, triazine, pyrrole, pyrrolidine, furan, thiophene, benzoxazole, benzothiazole, and triazole compounds, and/or aromatic-based surfactants, examples being mono-, or poly-alkyl-substituted and subsequently derivatized, e.g., alkoxylated, sulfated, sulfonated or phosphated, benzenes or phenols. The surfactants b) are generally soluble in the solvent phase and suitable for emulsifying this phase—together with actives dissolved therein—on dilution with water (to give the spray liquor). The surfactant/solvent mixtures of the invention may for example comprise nonaromatic or aromatic surfactants or mixtures of nonaromatic and aromatic surfactants.

Examples of surfactants are listed below, wherein EO=ethylene oxide units, PO=propylene oxide units, and BO=butylene oxide units:
b1) C₁₀-C₂₄ alcohols, which may be alkoxylated, with for example 1-60 alkylene oxide units, preferably 1-60 EO and/or 1-30 PO and/or 1-15 BO in any order. The terminal hydroxyl groups of these compounds may be endgroup-capped by an alkyl, cycloalkyl or acyl radical having 1-24 carbon atoms. Examples of such compounds are: Genapol® C, L, O, T, UD, UDD, X products from Clariant, Plurafac® and Lutensol® A, AT, ON, TO products from BASF, Malipal® 24 and O13 products from Condea, Dehypon® products from Henkel, and Ethylan® products from Akzo-Nobel such as Ethylan CD 120.
b2) Anionic derivatives of the products described under b1), in the form of ether carboxylates, sulfonates, sulfates, and phosphates, and their inorganic (e.g., alkali metal and alkaline earth metal) and organic salts (e.g., based on amine or alkanolamine), such as Genapol® LRO, Sandopan® products, and Hostaphat/Hordaphos® products from Clariant. Copolymers composed of EO, PO and/or BO units such as, for example, block copolymers such as the Pluronic® products from BASF and the Synperonic® products from Uniqema having a molecular weight of 400 to 10⁸. Alkylene oxide adducts of C₁-C₉ alcohols such as Atlox® 5000 from Uniqema or Hoe®-S3510 from Clariant.
b3) Fatty acid alkoxylates and triglyceride alkoxylates such as the Serdox®NOG products from Condea or alkoxylated vegetable oils such as soybean oil, rapeseed oil, corn germ oil, sunflower oil, cotton seed oil, linseed oil, coconut oil, palm oil, thistle oil, walnut oil, peanut oil, olive oil or castor oil, especially rapeseed oil, the vegetable oils also comprehending their transesterification products, examples being alkyl esters such as rapeseed oil methyl ester or rapeseed oil ethyl ester, examples being the Emulsogen® products from Clariant, salts of aliphatic, cycloaliphatic, and olefinic carboxylic acids and polycarboxylic acids, and also alpha-sulfo fatty acid esters of the kind obtainable from Henkel.
b4) Fatty acid amide alkoxylates such as the Comperlan® products from Henkel or the Amam® products from Rhodia; alkylene oxide adducts of alkynediols such as the Surfynol® products from Air Products; sugar derivatives such as amino sugars and amido sugars from Clariant, glucitols from Clariant, alkylpolyglycosides in the form of the APG® products from Henkel or such as sorbitan esters in the form of the Span® or Tween® products from Uniqema or cyclodextrin esters or ethers from Wacker.
b5) Surface-active cellulose derivatives and algin derivatives, pectin derivatives and guar derivatives such as the Tylose® products from Clariant, the Manutex® products from Kelco, and guar derivatives from Cesalpinia; polyol-based alkylene oxide adducts, such as Polyglykol® products from Clariant. Surface-active polyglycerides and their derivatives from Clariant.
b6) Alkanesulfonates, paraffin sulfonates, and olefin sulfonates such as Netzer IS®, Hoe®S1728, Hostapur®OS, Hostapur®SAS from Clariant, sulfosuccinate-based surfactants, such as dialkylsuccinates.
b7) Alkylene oxide adducts of fatty amines, quaternary ammonium compounds having 8 to 22 carbon atoms (C₈-C₂₂) such as the Genamin® C, L, O, T products from Clariant.
b8) Surface-active zwitterionic compounds such as taurides, betaines, and sulfobetaines in the form of Tegotain® products from Goldschmidt, Hostapon®T and Arkopon®T products from Clariant.
b9) Silicone-based and/or silane-based surface-active compounds, such as the Tegopren® products from Goldschmidt and the SE® products from Wacker, and also the Bevaloid®, Rhodorsil®, and Silcolapse® products from Rhodia (Dow Corning, Reliance, GE, Bayer).
b10) Perfluorinated or polyfluorinated surface-active compounds such as Fluowet® products from Clariant, the Bayowet® products from Bayer, the Zonyl® products from DuPont, and products of this kind from Daikin and Asahi Glass.
b11) Surface-active sulfonamides such as those from Bayer.
b12) Surface-active polyacrylic and polymethacrylic derivatives such as the Sokalan® products from BASF.
b13) Surface-active polyamides such as modified gelatins or derivatized polyaspartic acid from Bayer, and their derivatives.
b14) Polyvinyl surfactant-type compounds such as modified polyvinylpyrrolidone such as the Luviskol® products from BASF and the Agrimee® products from ISP, or the derivatized polyvinyl acetates such as the Mowilith® products from Clariant or the polyvinyl butyrates such as the Lutonal® products from BASF, the Vinnapas® and the Pioloform® products from Wacker, or modified polyvinyl alcohols such as the Mowiol® products from Clariant.
b15) Surface-active compounds based on maleic anhydride and/or reaction products of maleic anhydride, and also copolymers containing maleic anhydride and/or reaction products of maleic anhydride, such as the Agrimer® VEMA products from ISP.
b16) Surface-active derivatives of montan waxes, polyethylene waxes, and polypropylene waxes, such as the Hoechst® waxes or the Licowet® products from Clariant.
b17) Surface-active phosphonates and phosphinates such as Fluowet® PL from Clariant.
b18) Polyhalogenated or perhalogenated surfactants such as, for example, Emulsogen® 1557 from Clariant.
b19) Phenols, which may have been alkoxylated, examples being phenyl C₁-C₄ alkyl ethers or (poly)alkoxylated phenols [i.e., phenol (poly)alkylene glycol ethers], having for example 1 to 50 alkyleneoxy units in the (poly)alkyleneoxy moiety, the alkylene moiety having preferably 1 to 4 C atoms in each case, preferably phenol reacted with 3 to 10 mol of alkylene oxide, (poly)alkylphenols or (poly)alkylphenol alkoxylates [i.e., polyalkylphenol (poly)alkylene glycol ethers], having for example 1 to 12 C atoms per alkyl radical and 1 to 150 alkyleneoxy units in the polyalkyleneoxy moiety, preferably triisobutylphenol or tri-n-butylphenol reacted with 1 to 50 mol of ethylene oxide, polyarylphenols or polyarylphenol alkoxylates [i.e., polyarylphenol (poly)alkylene glycol ethers], examples being tristyrylphenol polyalkylene glycol ethers having 1 to 50 alkyleneoxy units in the polyalkyleneoxy moiety, preferably tristyrylphenol reacted with 1 to 50 mol of ethylene oxide.
b20) Compounds which, formally, constitute the reaction products of the molecules described in b19) with sulfuric acid or phosphoric acid, and their salts neutralized with suitable bases, by way of example the acidic phosphoric ester of triply ethoxylated phenol, the acidic phosphoric ester of a nonylphenol reacted with 9 mol of ethylene oxide, and the triethanolamine-neutralized phosphoric ester of the reaction product of 20 mol of ethylene oxide and 1 mol of tristyrylphenol.
b21) Benzenesulfonates such as alkyl- or arylbenzenesulfonates, examples being (poly)alkylbenzenesulfonates and (poly)aryl-benzenesulfonates, both acidic and neutralized with suitable bases, having for example 1 to 12 C atoms per alkyl radical and/or having up to 3 styrene units in the polyaryl radical, preferably (linear) dodecylbenzenesulfonic acid and its oil-soluble salts such as the calcium salt or the isopropylammonium salt of dodecylbenzene-sulfonic acid, for example.

Preferred among the alkyleneoxy units are ethyleneoxy, propyleneoxy, and butyleneoxy units, especially 1,2-ethyleneoxy units. In general these units are formed by reaction with epoxides, giving rise to 1,2-ethyleneoxy units and branched derivatives thereof, such as 1,2-propyleneoxy.

Examples of surfactants from the group of nonaromatic-based surfactants are the surfactants of aforementioned groups b1) to b18), preferably of groups b1), b2), b6), and b7).

Examples of surfactants from the group of aromatic-based surfactants are the surfactants of abovementioned groups b19)-b21), preferably phenol reacted with 4 to 10 mol of ethylene oxide, available commercially, for example, in the form of the Agrisol® products (Akcros), triisobutylphenol reacted with 4 to 50 mol of ethylene oxide, available commercially for example in the form of the Sapogenat® T products (Clariant), nonylphenol reacted with 4 to 50 mol of ethylene oxide, available commercially for example in the form of the Arkopal® products (Clariant), tristyrylphenol reacted with 4 to 150 mol of ethylene oxide, and where appropriate phosphated or sulfated, examples being surfactants from the Soprophor® series such as Soprophor® FL, Soprophor® 3D33, Soprophor® BSU, Soprophor® 4D-384, and Soprophor® CY/8 (Rhodia), and acidic (linear) dodecylbenzenesulfonate, available commercially for example in the form of the Marion® products (Hüls).

Preference is given to sulfosuccinate-based surfactants and nonionic surfactants and also to mixtures of nonionic surfactants and sulfosuccinate-based surfactants. Preference is given in this context to nonionic surfactants having a polyalkyleneoxy content of ≧10 units, particularly a polyethylene oxide content of ≧10 units, in particular 15 units.

The nonionic surfactants may for example carry a free hydroxyl group or may be protected by an alkyl group having 1 to 18 C atoms or aryl group.

Further preference is also given to surfactants from the group of the sulfosuccinates of the formula (I)

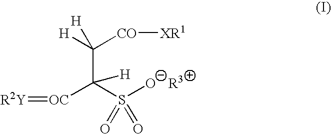

in which
R¹ and R² each independently are alike or different and are in each case hydrogen, an unsubstituted or substituted C₁-C₃₀ hydrocarbon radical, such as C₁-C₃₀ alkyl, or a (poly)alkylene oxide adduct,
R³ is a cation, a metal cation for example such as an alkali metal or alkaline earth metal cation, an ammonium ion such as NH₄, an N-substituted primary, secondary, tertiary or quaternary ammonium ion with alike or different radicals from the group consisting of alkyl, alkylaryl, and poly(arylalkyl)phenyl or the (poly)oxyalkylene oxide adducts thereof, or an amino-terminal (poly)alkylene oxide adduct, and
X and Y each independently are alike or different and are in each case a divalent radical —O— or —NR⁴—, in which R⁴ is hydrogen, an unsubstituted or substituted C₁-C₃₀ hydrocarbon radical such as C₁-C₃₀ alkyl, (C₁-C₃₀ alkyl)-C₆-C₁₄ aryl or poly[(C₆-C₁₄ aryl)-C₁-C₃₀ alkyl]phenyl, dicarboxyethyl or a (poly)alkylene oxide adduct.

(Poly)alkylene oxide adducts for the purposes of this description are reaction products of alkoxylatable starting materials such as alcohols, amines, carboxylic acids, such as fatty acids, hydroxy- or amino-functional carboxylic esters (examples being triglycerides based on castor oil) or carboxamides with alkylene oxides, the (poly)alkylene oxide adducts having at least one alkylene oxide unit, but generally being polymeric, i.e., having 2-200, preferably 5-150, alkylene oxide units. Among the alkylene oxide units, ethylene oxide, propylene oxide, and butylene oxide units, especially ethylene oxide units, are preferred. The (poly)alkylene oxide adducts described may be composed of alike or of different alkylene oxides, as for example of blockwise or randomly arranged ethylene oxide and propylene oxide, so that the present specification also encompasses “mixed” alkylene oxide adducts of this kind.

Examples of preferred sulfosuccinate compounds are:
a1) sulfosuccinate which is singly or doubly esterified with linear, cyclic or branched aliphatic, cycloaliphatic and/or aromatic alcohols having 1 to 22 C atoms in the alkyl radicals, preferably mono- or di-alkali metal sulfosuccinate, especially mono- or di-sodium sulfosuccinate, esterified singly or doubly with methanol, ethanol, (iso)propanol, (iso)butanol, (iso)pentanol, (iso)hexanol, cyclohexanol, (iso)heptanol, (iso)octanol (especially ethylhexanol), (iso)nonanol, (iso)decanol, (iso)undecanol, (iso)dodecanol or (iso)tridecanol,
a2) sulfosuccinate which is esterified singly or doubly with (poly)alkylene oxide adducts of alcohols, having for example 1 to 22 C atoms in the alkyl radical and 1 to 200, preferably 2 to 200, alkylene oxide units in the (poly)alkylene oxide moiety, preferably mono- or di-alkali metal sulfosuccinate, especially mono- or di-sodium sulfosuccinate, esterified singly or doubly with dodecyl/tetradecyl alcohol +2-5 mol of ethylene oxide or with isotridecyl +3 mol of ethylene oxide,
a3) the dialkali metal salt, preferably the disodium salt, of maleic anhydride reacted singly with amines or amino-terminated (poly)alkylene oxide adducts of alcohols, amines, fatty acids, esters or amides, and subsequently sulfonated, having for example 1 to 22 C atoms in the alkyl radical and 1 to 200, preferably 2 to 200, alkylene oxide units in the (poly)alkylene oxide moiety, preferably the disodium salt of maleic anhydride which is reacted singly with coconut fatty amine and is subsequently sulfonated,
a4) the dialkali metal salt, preferably the disodium salt, of maleic anhydride reacted singly with amides or (poly)alkylene oxide adducts of amides, and subsequently sulfonated, said anhydride having for example 1 to 22 C atoms in the alkyl radical and 1 to 200, preferably 2 to 200, alkylene oxide units in the (poly)alkylene oxide moiety, preferably disodium salt of maleic anhydride reacted singly with oleylamide and subsequently sulfonated, and/or
a5) the tetraalkali metal salt, preferably the tetrasodium salt, of N-(1,2-dicarboxyethyl)-N-octadecylsulfosuccinamate.

Examples of sulfosuccinates from groups a1) to a5) that are available commercially and are preferred in the context of the present invention are listed below:
a1) sodium dialkylsulfosuccinates, Na diisooctylsulfosuccinate for example, available commercially for example in the form of Aerosol® products (Cytec), Agrilan® or Lankropol® products (Akzo Nobel), Empimin® products (Albright&Wilson), Cropol® products (Croda), Lutensit® products (BASF), Imbirol®, Madeol® or Polirol® products (Cesalpinia) or sodium di(2-ethylhexyl)sulfosuccinates such as the Triton® products (Union Carbide) such as Triton® GR-5M and Triton® GR-7ME,
a2) disodium alkyl polyethylene glycol ether semisulfosuccinate, available commercially for example in the form of Aerosol® products, Marlinat® or Sermul® products (Condea), Empicol® products (Albright&Wilson), Secosol® products (Stepan), Geropon® products (Rhodia), Disponil® products or Texapon® products (Cognis) or Rolpon® products (Cesalpinia),
a3) disodium N-alkylsulfosuccinamate, available commercially for example in the form of Aerosol® products (Cytec), Rewopol® products or Rowoderm® products (Rewo), Empimin® products (Albright&Wilson), Geropon® products (Rhodia) or Polirol® products (Cesalpinia),
a4) disodium fatty acid amide polyethylene glycol ether semisulfosuccinate, available commercially for example in the form of Elfanol® or Lankropol® products (Akzo Nobel), Rewoderm® products, Rewocid® or Rewopol® products (Rewo), Emcol® products (Witco), Standapol® products (Cognis) or Rolpon® products (Cesalpinia), and
a5) tetrasodium N-(1,2-dicarboxyethyl)-N-octadecylsulfosuccinamate, available commercially for example in the form of Aerosol 22® (Cytec).

The aqueous phase of the dispersions- of the invention also comprises, where appropriate, surface-active formulating auxiliaries (surfactants) from the specific group of the dispersants for physical stabilization of the formulations, as for example of the capsule suspensions.

These may be ionic or nonionic dispersants, aromatic or nonaromatic dispersants, including, for example, polymers.

The amount of dispersants in this case is for example 0.5% to 30%, preferably 0.5%-20%, in particular 2% to 15% by weight.

The dispersants hail for example from a group which encompasses, for example, the classes of the polyvinyl alcohols, the polyalkylene oxides, the condensation products of formaldehyde with naphthalenesulfonic acids and/or phenols, the polyacrylates, the copolymers of maleic anhydride with alkylene alkyl ethers, the lignosulfonates, and the polyvinylpyrrolidones. These compounds are used preferably in an amount of 0.2% to 10% by weight, in particular of 0.5% to 4% by weight, based in each case on the overall dispersion.

Among the polyalkylene oxides, preference is given to block copolymers whose molecular center is formed by a polypropylene oxide block but whose molecular periphery is formed by polyethylene oxide blocks. Particular preference is given in this context to those compounds in which the polypropylene block has a molar mass of 2000-3000 and the polyethylene oxide blocks account for a fraction of 60% to 80% of the overall molar mass. A compound of this kind is sold by BASF Wyandotte, for example, under the name Pluronic® F87.

Further suitable dispersants are calcium lignosulfonate, highly refined sodium lignosulfonate (e.g., Vanisperse® CB from Borregaard), dispersant S and dispersant SS from Clariant GmbH, naphthalenesulfonic-formaldehyde condensation product sodium salt (e.g., Morwet® D 425 from Witco or Tamol® NN 8906 from BASF), and sodium polycarboxylate (e.g., Sopropan® T 36 from Rhodia GmbH).
Suitable polyvinyl alcohols are prepared by partial hydrolysis of polyvinyl acetate. They have a degree of hydrolysis of 72 to 99 mol % and a viscosity of 2 to 18 cP (measured in 4% strength aqueous solution at 20° C. in accordance with DIN 53 015). It is preferred to use partially hydrolyzed polyvinyl alcohols having a degree of hydrolysis of 83 to 88 mol % and a low viscosity, in particular from 3 to 5 cP.

Where appropriate, the aqueous phase of the dispersions comprises at least one further formulating auxiliary from the range of antifreeze agents, thixotropic agents and thickeners, preservatives and biocides, density enhancers, defoamers, antidrift agents, stickers, penetrants, antioxidants, carriers and fillers, odorants, fertilizers, evaporation inhibitors, and stabilizers, to counter pH fluctuations, for example (buffers) or to counter UV light, and dyes.

Examples of preservatives which can be added to the aqueous dispersions include the following agents (biocides): formaldehyde or hexahydrotriazine derivatives, such as Mergal® KM 200 from Riedel-de Haen or Cobate® C from Rhone Poulenc, isothiazolinone derivatives, such as Mergal® K9N from Riedel-de Haen or Kathon® CG from Rohm and Haas, 1,2-benzoisothiazolin-2-ones, such as Nipacide® BIT 20 from Nipa Laboratorien GmbH or Mergal® K10 from Riedel-de Häen or 5-bromo-5-nitro-1,3-dioxane (Bronidox® LK from Henkel). The fraction of these preservatives is not more than 2% by weight, based on the overall formulation.

Examples of suitable antifreeze agents are monohydric or polyhydric alcohols, glycol ethers or urea, especially calcium chloride, glycerol, isopropanol, propylene glycol monomethyl ether, di- or tripropylene glycol monomethyl ether or cyclohexanol. The fraction of these antifreeze agents is not more than 20% by weight, based on the overall dispersion.

Thickeners may be organic or inorganic in nature; they may also be combined. Suitable examples include those based on aluminum silicate, on xanthan, on methylcellulose, on polysaccharide, on alkaline earth metal silicate, on gelatin, and on polyvinyl alcohol, such as Bentone® EW, Veegum®, Rhodopol® 23 or Keizan® S, for example. Their fraction is 0.3% by weight, preferably 0%-0.5% by weight, based on the overall dispersion.

If solvents are utilized in the formulations that have not been physically “shielded”, as for example by microcapsules, then they are further formulating auxiliaries used optionally. Suitable solvents in this context include those organic solvents that are already suitable for the microcapsules, and also other solvents which in particular are miscible with the aqueous phase, examples being polar organic solvents such as
ethers such as diethyl ether, tetrahydrofuran (THF), dioxane,
alcohols such as methanol, ethanol, propanol, isopropanol, butanol,
ketones, examples being water-miscible ketones such as acetone,
nitriles such as acetonitrile, propionitrile, butyronitrile, and benzonitrile, and
sulfoxides and sulfones such as dimethyl sulfoxide (DMSO) and sulfolan.

The density enhancers or density modifiers are for example water-soluble compounds such as inorganic salts—calcium chloride or copper sulfate, for example—or else polyols—such as glycerol, for example—for the purpose, for example, of modifying the density of the aqueous phase.

The typical auxiliaries and additives (4) which are present optionally in the active formulations of the invention are known in principle and are described for example in standard works: McCutcheon's “Detergents and Emulsifiers Annual”, MC Publ. Corp., Ridgewood N.J.; Sisley and Wood, “Encyclopedia of Surface active Agents”, Chem. Publ. Co. Inc., N.Y. 1964; Schönfeldt, “Grenzflächenaktive Äthylenoxidaddukte”, Wiss. Verlagsgesellschaft, Stuttgart 1976; Winnacker-Küchler, “Chemische Technologie”, Vol. 7, C. Hanser-Verlag, Munich, 4th edition 1986.

Optionally, further agrochemical actives, up to 50%, preferably up to 30%, by weight of actives, present in addition to the microencapsulated ACCase inhibitor in the formulation, may be in dispersion, in solution in water or emulsified, where appropriate in solution in a solvent, or else may themselves be microencapsulated. These further agrochemical actives are preferably those which do not antagonize the activity of the actives that are freely available in the formulation and come from the group of the fatty acid synthetase inhibitors and, preferably, ACCase inhibitors.

Suitable actives which may be embedded in the carrier materials used in accordance with the invention are not confined to specific classes, and encompass all known classes of agrochemical actives. Examples are herbicides, fungicides, insecticides, growth regulators, safeners, molluscicides, acaricides, and nematicides.

For all of the aforementioned agrochemical actives it is of course also possible where appropriate to use the corresponding derivative that the artisan knows to be suitable for use, such as acids, esters or salts of the actives.

Examples of suitable optional actives are:

herbicides from the group of phenoxyalkanecarboxylic acids and their derivatives, such as 2,4-D-based on MCPA-based herbicides (esters, acids, salts, preferably esters);

bromoxynil and its derivatives (esters, phenols, salts, preferably esters);

fluroxypyr and its derivatives (esters, acid, salts, preferably esters).

Preference is given to microcapsule suspensions with herbicidal actives, particularly those in which the only actives present are one or more herbicidal actives. In accordance with the invention there is always a fatty acid synthetase inhibitor included.

The invention also relates to a method of producing the microcapsule dispersions of the invention which comprises first preparing a coarse preliminary emulsion of organic phase and aqueous phase (without diamine or polyamine) and then subjecting it to shearing forces by passing it, preferably, through a continuously operating mixing apparatus, such as a static mixer, a toothed colloidal mill or the like. Only this step produces the state of fine division of the emulsified oil droplets that is needed for the subsequent formation of microcapsules. Finally, where appropriate following addition of a diamine or polyamine, curing takes place by polymerization throughout the volume of material. An alternative option is to forego the addition of the water-soluble amines or polyamines and to stir the completed emulsion over a certain period of time at a suitable temperature, as for example at 70° C. over 6 h.

The size (particle size) of the microcapsules is generally less than 50 μm, as a rule less than 20 μm, and preferably less than 15 μm.

The weight ratio of wall material, prepared for example from di/polyisocyanates and, where appropriate, diamines and/or polyamines, to the encapsulated organic phase, i.e., to the solvent and also the lipophilic actives and, where appropriate, lipophilic auxiliaries dissolved therein, is preferably in the range from 1:200 to 1:10, preferably from 1:100 to 1:50.

Instead of microencapsulation it is also possible, for the purpose of producing a controlled release combination, to incorporate the active into an organic matrix such as wax, for example. Inorganic matrices can also be used, examples being silicates, aluminosilicates or aluminum oxides or minerals based on said materials. When incorporated into an organic or inorganic matrix of this kind, the agrochemical actives are bound physically.

The controlled release formulations obtained in this way can be applied directly to plants; alternatively, they can also be processed further to coformulations. These coformulations may include further components such as further ACCase inhibitors or further agrochemical actives or else adjuvants, examples being surfactants such as fatty alcohol ethoxylates or sulfosuccinate-based surfactants. These additional components may be in solution, emulsion or suspension in the aqueous phase of, for example, microcapsule suspensions. This can be achieved for example by mixing a microcapsule suspension with a water-soluble component, such as with an aqueous or water-soluble solution, or with a water-soluble active or adjuvant, with an emulsion concentrate or emulsifiable concentrate and/or with a dispersion. These steps of dissolving, emulsifying, mixing and/or suspending are well known to the artisan, and the techniques and auxiliary means are described in the art literature on the preparation of, for example, emulsifiable concentrates, solutions, oil-in-water emulsions, and suspension concentrates.

Possible release mechanisms are, for instance, abiotic and/or biotic breakdown (weathering), the bursting of the matrix or of the capsule walls, after loss of moisture, for example, or diffusion or dissolution of the active from the matrix or the capsules. This may take place as a function of contact with liquids, such as water, or as a function of the temperature.

The release of the major amount of the active from the matrix or microcapsules occurs, generally speaking, within the first 4 weeks after application, preferably within the first 7 days, and more particularly within the first 3 days.

Actives which are not released controllably may be used either as commercial products, such as in tank mixes, or can be formulated in accordance with technologies which are known in principle, and can be combined in the tank with the corresponding controlled release formulations.

The formulations used in accordance with the invention permit a reduction in the phytotoxic side effects of the actives on the crop plants. Preference is given here to economically important crops such as wheat, barley, rye, triticale, oats, millet, rice, manioc, and corn, or else crops of sugar beet, cotton, soybean, oil seed rape, potato, tomato, pea, and other vegetable varieties.

Actives microencapsulated in accordance with the invention can therefore be used in a mixture of other actives, together where appropriate with the typical additives and adjuvants. Examples of preferred formulations of the invention are described below. In all of these formulations the use of the actives which have been described above as being particularly suitable or most suitable is of course likewise preferred, even when such preference is not specifically mentioned.

The formulations of the invention exhibit excellent efficacy. In the case of the formulation of herbicides as actives, they have an excellent herbicidal efficacy against a broad spectrum of economically important monocotyledonous and dicotyledonous weeds. Even perennial weeds which are difficult to control, which produce shoots from seeds or rhizomes, root stocks or other perennial organs, are effectively covered by the combined actives. It is immaterial here whether formulations of the invention are applied pre-sowing, preemergence or postemergence. The formulations of the invention are preferably applied to above-soil plant parts. The formulations of the invention are also suitable for the desiccation of crop plants such as potato, cotton, and sunflower.

In the case of herbicidal actives the formulations of the invention may be used, for example, to control the following weeds:

Dicotyledonous weeds of the genera Sinapis, Gallium, Stellaria, Matricaria, Galinsoga, Chenopodium, Brassica, Urtica, Senecio, Amaranthus, Portulaca, Xanthium, Convolvulus, Ipomoea, Polygonum, Sesbania, Cirsium, Carduus, Sonchus, Solanum, Lamium, Veronica, Abutilon, Datura, Viola, Monochoria, Commalina, Sphenoclea, Aeschynomene, Heteranthera, Papaver, Euphorbia, and Bidens.

Monocotyledonous weeds of the genera Avena, Alopecurus, Echinochioa, Setaria, Pancium, Digitaria, Poa, Eleusine, Brachiaria, Lolium, Bromus, Cyperus, Elytrigia, Sorphum, Apera, and Scirpus.

Where the herbicidal compositions comprising the formulations of the invention are applied prior to germination, either the emergence of the weed seedlings is prevented completely, or else the weeds grow until they reach the cotyledon stage, but then stop growing and, finally, after three or four weeks have elapsed, die off entirely.

When these herbicidal compositions comprising the formulations of the invention are applied to the green parts of weeds postemergence, there is likewise a drastic halt in growth very rapidly after treatment. The weed plants remain in the growth stage they were in at the time of application, or die off more or less quickly after a certain time, so that in this way any weed competition, which is harmful to crop plants, can be prevented very early and sustainably through the use of the new, inventive formulations, as can the associative quantitative and qualitative yield losses.

Although these formulations of the invention exhibit excellent herbicidal activity against monocot and dicot weeds, phytotoxic damage to crop plants is reduced, and damage to the crop plants is insignificant or completely absent.

These effects make it possible, among other things, to optimize the application rate, to control a broader spectrum of broadleaf and gramineous weeds, to close gaps in activity, including those relating to resistant species, and also allow more rapid and more reliable activity, a longer long-term activity, the complete checking of weeds with only one or few applications, and an extension to the period of application where there is a plurality of actives present simultaneously.

The aforementioned properties are required in the practice of weed control in order to keep agricultural crops free from unwanted competitor plants and hence to safeguard and/or increase yield quality and quantity. In respect of the properties described, the formulations of the invention significantly exceed the technical standard.

Furthermore, the formulations of the invention outstandingly allow the control of weeds which are otherwise resistant.

On account of their agrochemical properties, preferably herbicidal, plant growth regulatory, and safener properties, the formulations of the invention, used preferably in herbicidal compositions, can also be used to control weeds in crops of genetically modified plants that are known or yet to be developed. The transgenic plants are distinguished in general by particular advantageous properties, as for example by resistances to particular pesticides, especially particular herbicides, resistances to plant diseases or plant-disease pathogens such as certain insects or microorganisms such as fungi, bacteria or viruses. Other special properties relate, for example, to the harvested material, with regard to quantity, quality, storability, composition, and specific constituents. For instance, there are transgenic plants known which have an increased starch content or a modified starch quality, or whose harvested material has a different fatty acid composition.

Preference is given to the use of the formulations of the invention in economically important transgenic cultures of crop plants and ornamentals, such as of cereals such as wheat, barley, rye, triticale, oats, millets, rice, cassava, and corn, or else cultures of sugar beet, cotton, soybean, oilseed rape, potato, tomato, pea, and other vegetable varieties.

With preference the formulations of the invention with herbicides, plant growth regulators and/or safeners can be used in crops which are resistant or have genetically been made resistant to the phytotoxic effects of the herbicides.

Conventional routes to producing new plants which have modified properties as compared with existing plants consist for example in traditional breeding methods and in the generation of mutants. Alternatively it is possible to produce new plants having modified properties with the aid of recombinant methods (see, for example, EP-A-0 221 044, EP-A-0 131 624). By way of example there have been descriptions in a number of cases of the following:
recombinant modifications of crop plants for the purpose of modifying the starch synthesized in the plants (e.g., WO 92/11376, WO 92/14827, WO 91/19806),
transgenic crop plants which are resistant to certain herbicides of the glufosinate type (cf., e.g., EP-A-0 242 236, EP-A-0 242 246) or glyphosate type (WO 92/00377) or of the sulfonylurea type (EP-A-0 257 993, U.S. Pat. No. 5,013,659),
transgenic crop plants, cotton for example, with the ability to produce Bacillus thuringiensis toxins (Bt toxins), which render the plants resistant to certain pests (EP-A-0 142 924, EP-A-0 193 259),
transgenic crop plants with a modified fatty acid composition (WO 91/13972).

There are numerous techniques of molecular biology which can be used to produce new transgenic plants with modified properties and which are known in principle; see, for example, Sambrock et al., Molecular Cloning, A. Laboratory Manual, 2nd ed., Cold Spring Harbor Laboratory Press, Cold Spring Harbor, N.Y., or Winnacker “Gene und Klone”, VCH Weinheim, 2nd edition 1996, or Christou, “Trends in Plant Science” 1 (1996) 423-431.

For genetic manipulations of this kind it is possible to introduce nucleic acid molecules into plasmids that permit mutagenesis or an alteration in sequence by recombination of DNA sequences. With the aid of the standard techniques referred to above it is possible, for example, to carry out base substitutions, to remove partial sequences or to add natural or synthetic sequences. For connecting the DNA fragments to one another it is possible to attach adapters or linkers to the fragments.

The production of plant cells with a reduced activity of a gene product can be achieved, for example, through the expression of at least one corresponding antisense RNA, a sense RNA for achieving a cosuppression effect, or the expression of at least one appropriately constructed ribozyme which specifically cleaves transcripts of the aforementioned gene product.

For this purpose it is possible on the one hand to use DNA molecules which encompass all of the coding sequence of the gene product, including any flanking sequences present, and, on the other hand, DNA molecules which encompass only parts of the coding sequence, it being necessary for these parts to be long enough to bring about an antisense effect in the cells. Also possible is the use of DNA sequences which have a high degree of homology with the coding sequences of a gene product, but are not entirely identical.

When nucleic acid molecules are expressed in plants, the synthesized protein may be localized in any desired compartment of the plant cell. However, in order to achieve localization in a particular compartment, it is possible, for example, for the coding region to be linked to DNA sequences which ensure localization in one particular compartment. Such sequences are known to the artisan (see, for example, Braun et al., EMBO J. 11 (1992), 3219-3227; Wolter et al., Proc. Natl. Aca. Sci. USA 85 (1988), 846-850; Sonnewal et al., Plant J. 1 (1991), 95-106).

The transgenic plant cells can be regenerated by known techniques to give whole plants. The transgenic plants may in principle be plants of any desired species, i.e., both monocotyledonous and dicotyledonous plants.

Thus there are transgenic plants obtainable which exhibit modified properties as a result of overexpression, suppression or inhibition of homologous (i.e., natural) genes or gene sequences or expression of heterologous (i.e., foreign) genes or gene sequences.

With preference the formulations of the invention can be used in transgenic crops which are resistant to herbicides from the group of sulfonylureas, imidazolinones, glufosinate-ammonium or glyphosate-isopropyl ammonium, and related actives.

When the formulations of the invention, particularly the corresponding herbicidal formulations, are employed in transgenic crops, there are frequently effects observed—as well as the effects against weed plants that are observed in other crops too—that are specific for the application in the particular transgenic crop in question: for example, a modified or specifically widened controllable weed spectrum; a modified application rate that can be used for comparable application; preferably, good combinability or partnerability with the herbicides to which the transgenic crop is resistant; and the influencing of growth and yield in the transgenic crop plants.

The invention is now additionally elucidated in the examples which follow, without any intention that it should be restricted to these examples.

### EXAMPLES

### A) FORMULATING EXAMPLES

### Example 1a

(I) 7.28 g of fenoxaprop-P-ethyl (94.8% D-(+)-isomer) were dissolved in 20.0 g of Solvesso® 200ND, and then 0.5 g of Voranate® M220 (Dow Chemicals, technical-grade methylenediphenyl diisocyanate) was incorporated by stirring until the composition was completely homogeneous.
(II) Furthermore, an aqueous solution consisting of 5.0 g of Mowiol® 3-83 (Clariant, polyvinyl alcohol), 4.5 g of Genapol® V4829 (Clariant, ethylene oxide/propylene oxide copolymer), 0.05 g of Rhodorsil® 432 (Rhodia, silicone-based defoamer), 0.01 g of Acticide® MBS (preservative) and 45.0 g of water was prepared.
(III) A stirred vessel equipped with dropping funnel and stirring motor/paddle stirrer was charged with the aqueous phase from (II), and the organic phase from (I) was added rapidly with stirring. After about 0.5 h the stirring speed was reduced and an aqueous solution of 0.62 g of hexamethylenediamine in 1 g of water was metered in. Shortly after that, 2.0 g of glycerol (technical grade) were added. Stirring was continued at the same speed for a further 4 h at room temperature and then 15 g of Genapol X-150 (isotridecyl alcohol polyglycol ether with 15 EO) were added. This gave a microcapsule dispersion containing 7.28% fenoxaprop-P-ethyl (see also Table 1).

### Example 1b

The procedure of Example 1a was repeated but adding, when preparing the aqueous solution, instead of 15 g of Genapol X-150 (isotridecyl alcohol polyglycol ether with 15 EO), a mixture of 5 g of Genapol X-150 and 10 g of BEHSS-Na [i.e., bis(2-ethylhexyl)sulfosuccinate sodium] (see also Table 1).

### Examples 2 to 10

The procedures of Examples 1a and 1b were applied analogously in order to prepare the microcapsule formulations whose compositions are specified in Tables 1 and 2.

TABLE 1

| Composition/components | 1a | 1b | 2 | 3 | 4⁴⁾ |
|---|---|---|---|---|---|
| FPE | 7.28 | 7.28 | 0.00 | 0.00 | 0.00 |
| Clethodim (92% active | 0.00 | 0.00 | 7.57 | 7.57 | 7.57 |
| content) | | | | | |
| Water¹⁾ | 45.00 | 45.00 | 49.73 | 50.19 | 50.18 |
| Solvesso 200ND | 20.00 | 20.00 | 20.00 | 20.00 | 20.00 |
| Glycerol, technical-grade | 2.00 | 2.00 | 2.00 | 2.00 | 2.00 |
| Mowiol 3-83 (20%)²⁾ | 5.00 | 5.00 | 5.00 | 5.00 | 5.00 |
| Genapol V4829 (20%)²⁾ | 4.50 | 4.50 | 4.50 | 4.50 | 4.50 |
| Voranate M220 | 0.50 | 0.50 | 0.00 | 0.00 | 0.00 |
| TMXDI | 0.00 | 0.00 | 0.50 | 0.50 | 0.65 |
| DETA | 0.00 | 0.00 | 0.00 | 0.14 | 0.00 |
| Hexamethylenediamine | 0.62 | 0.62 | 0.60 | 0.00 | 0.00 |
| (40%)²⁾ | | | | | |
| Acticide MBS | 0.05 | 0.05 | 0.05 | 0.05 | 0.05 |
| Rhordorsil 432 | 0.05 | 0.05 | 0.05 | 0.05 | 0.05 |
| Genapol X-150³⁾ | 15.00 | 5.00 | 10.00 | 10.00 | 10.00 |
| BEHSS-Na³⁾ | 0.00 | 10.00 | 0.00 | 0.00 | 0.00 |
| | 100.00 | 100.00 | 100.00 | 100.00 | 100.00 |

TABLE 2

| Composition | 5 | 6 | 7 | 8 | 9 | 10⁴⁾ |
|---|---|---|---|---|---|---|
| Clethodim (92%) | 7.57 | 7.57 | 7.57 | 7.57 | 7.57 | 7.57 |
| Water¹⁾ | 49.73 | 50.19 | 50.19 | 44.73 | 44.73 | 45.18 |
| Solvesso 200ND | 20.00 | 20.00 | 20.00 | 20.00 | 20.00 | 20.00 |
| Glycerol, technical-grade | 2.00 | 2.00 | 2.00 | 2.00 | 2.00 | 2.00 |
| Mowiol 2-83 (20%)²⁾ | 5.00 | 5.00 | 5.00 | 5.00 | 5.00 | 5.00 |
| Genapol V4829 (20%)²⁾ | 4.50 | 4.50 | 4.50 | 4.50 | 4.50 | 4.50 |
| TMXDI | 0.50 | 0.50 | 0.50 | 0.50 | 0.50 | 0.65 |
| DETA | 0.00 | 0.14 | 0.14 | 0.00 | 0.00 | 0.00 |
| Hexamethylenediamine (40%)²⁾ | 0.60 | 0.00 | 0.00 | 0.60 | 0.60 | 0.00 |
| Acticide MBS | 0.05 | 0.05 | 0.05 | 0.05 | 0.05 | 0.05 |
| Rhordorsil 432 | 0.05 | 0.05 | 0.05 | 0.05 | 0.05 | 0.05 |
| Emulsogen EL400³⁾ | 0.00 | 0.00 | 0.00 | 0.00 | 0.00 | 5.00 |
| BEHSS-Na³⁾ | 0.00 | 0.00 | 0.00 | 10.00 | 10.00 | 10.00 |
| Genapol X-150³⁾ | 0.00 | 0.00 | 0.00 | 5.00 | 0.00 | 0.00 |
| Genapol X-150-Me³⁾ | 0.00 | 0.00 | 10.00 | 0.00 | 0.00 | 0.00 |
| Genapol X-060³⁾ | 10.00 | 0.00 | 0.00 | 0.00 | 5.00 | 0.00 |
| Genapol X-060-Me³⁾ | 0.00 | 10.00 | 0.00 | 0.00 | 0.00 | 0.00 |
| | 100.00 | 100.00 | 100.00 | 100.00 | 100.00 | 100.00 |

Notes and further abbreviations for Tables 1 and 2:
Notes:
¹⁾Residual water (total water content = residual water content + fractions of water in the individual components)
²⁾In each case as an aqueous solution
³⁾Addition in each case after formation of microcapsules
⁴⁾Capsule formation without diamines or polyamines at elevated temperature (70° C.)

Further abbreviations for Tables 1 and 2:
Acticide MBS Bactericide solution including 1,2-benzisothiazol-3(2H)-one and 2-methyl-2H-isothiazol-3-one as active ingredients
DETA Diethylenetriamine
Emulsogen EL400 Castor oil ethoxylate with 40 EO
BEHASS-Na Bis(2-ethylhexyl)sulfosuccinate Na
Genapol X-150 Isotridecyl alcohol polyglycol ether with 15 EO
Genapol X-150-Me Modified isotridecyl alcohol polyglycol ether with 15 EO (terminally etherified with methanol)
Genapol X-060 Isotridecyl alcohol polyglycol ether with 6 EO
Genapol X-060-Me Modified isotridecyl alcohol polyglycol ether with 6 EO (terminally etherified with methanol)
Genapol V4829 Block copolymer of ethylene oxide and propylene oxide
Mowiol 3-83 Polyvinyl alcohol, partially hydrolyzed (Clariant)
Rhodorsil 432 Silicone emulsion (defoamer from Rhodia)
Solvesso 200 ND Aromatic mineral oil (boiling range 219-281° C.)
TMXDI α,α,α′,α′-Tetramethyl-m-xylylene diisocyanate, also called 1,3-bis(1-isocyanato-1-methylethyl)benzene
Voranate M220 Methylene diisocyanate

Further information on preparation:

The size (particle size) of the microcapsules prepared is generally less than 50 μm, as a rule less than 20 μm, and preferably less than 15 μm. Preferred microcapsule suspensions contain microcapsules having a particle size distribution, measured on the basis of the d(10) particle diameter in the range up to 4 μm, in particular up to 1.5 μm, or measured on the d(50) particle diameter in the range up to 10 μm, in particular up to 5 μm, or measured on the d(90) particle diameter in the range up to 15 μm, in particular up to 10 μm.

The indications d(10), d(50), and d(90) here mean that 10%, 50%, and 90%, respectively, of the particles (fractions based on the volume) are smaller in diameter than that stated size in μm. The d50 value can be considered approximately as an average value of the diameter (though does not correspond exactly to the mathematical average), the indications of the three values d(10), d(50), and d(90) together being used as a measure of the breadth of distribution, or polydispersity of the distribution (strongly monodisperse is represented by d10=d50=d90). The values d(10), d(50), and d(90) for the capsule diameter can be determined for example by means of a laser diffraction spectrometer, an example being the instrument Coulter LS230.

Further formulating examples for microcapsule formulations (CS formulations)

In analogy to the methods given it is also possible to encapsulate further actives (other than fatty acid synthetase inhibitors) and to combine them with encapsulated fatty acid synthetase inhibitors, by means for example of a coformulation, or in the spray liquor.

In coformulations the fatty acid synthetase inhibitors may be microencapsulated together with or separately from other agrochemical actives.

Where they are separately microencapsulated, coformulations may for example also be obtained by the mixing of two or more microcapsule formulations each containing different actives.

Where the different actives are to be microencapsulated together, it is possible by way of example to dissolve all of the actives in solution, to prepare an emulsion from this solution, and then to microencapsulate the droplets of the emulsion.

All of the CS formulations described can be prepared by the same process, i.e., with comparable wall materials, comparable capsule dimensions, as measured by d(10), d(50), and d(90) (see elucidations earlier on above), and comparable ratio of organic phase to wall material. The loading of the CS formulation with “encapsulated” actives (fatty acid synthetase inhibitors and optional other agrochemical actives) is preferably in the range from 0.3% to 70% by weight.

### B) BIOLOGICAL EXAMPLES

Postemergence Application

Postemergence Weed Activity

Rice plant seedlings and typical rice weeds were cultivated under glass under Paddy rice conditions (water level: 2-3 cm) in pots under good growth conditions (temperature, humidity, water supply) and were treated at the two to three leaf stage with the actives. The actives, formulated as CS formulations or as oil-in-water emulsions, were sprayed at various dosages onto the green plant parts at an application rate of 300 l of water per ha (converted). After the test plants had stood under glass under optimum growth conditions for approximately 3 to 4 weeks, the activity of the products was scored visually in comparison to untreated controls. The scoring covered damage and development of all above-soil plant parts. Scoring was carried out on a percentage scale (100% activity=all plants died; 50% activity=50% of the plants and green plant parts died; 0% activity=no discernible activity=same as control). Results are summarized in Table 3.

The experiment shows that the CS formulation has a comparable activity on the weeds in combination with an improved crop plant tolerance.

TABLE 3
Application of herbicides against weeds in rice

| | | |
|---|---|---|
| | Rice | |
| Herbicide | ORYSA | Weeds |

| Formulation | g Al/ha | Balilla | DIGSA | ECHCG |
|---|---|---|---|---|
| Standard EW | 90 | 40 | 100 | 100 |
| | 45 | 40 | 85 | 100 |
| CS formulation | 90 | 15 | 95 | 100 |
| | 45 | 10 | 95 | 100 |

Abbreviations:
Al = active ingredient (=based on 100% active)
Standard EW = standard oil-in-water formulation of fenoxaprop-P-ethyl (Whip)
CS formulation = microcapsule formulation of fenoxaprop-P-ethyl according to Example 1a of Table 1 (see Formulating Examples)
ORYSA = Oryza sativa (rice)
DIGSA = Digitaria sativa
ECHCG = Echinochloa crus-galli

What is claimed is:

1. A method for reducing phytotoxicity of agrochemical actives from the group of fatty acid synthetase inhibitors in crop plants wherein a delayed-release formulation of the agrochemical actives is used when said agrochemical actives are used for controlling unwanted detrimental organisms in crops of said crop plants.

2. The method as claimed in claim 1, wherein the formulation is a microcapsule formulation or a wax dispersion.

3. The method as claimed in claim 2, wherein the formulation is a microcapsule formulation containing
a) 0.3 to 60 weight percent of one or more actives from the group of fatty acid synthetase inhibitors, wholly or partly microencapsulated,
b) 5 to 80 weight percent of organic solvents or solvent mixtures,
c) 5 to 80 weight percent of water,
d) 0 to 30 weight percent of one or more aromatic or nonaromatic surfactants,
e) 0 to 30 weight percent of one or more dispersants for physical stabilization,
f) 0 to 50 weight percent of further agrochemical actives, and
g) 0 to 30 weight percent of further formulating auxiliaries.

4. The method as claimed in claim 3, the formulation containing
a) 0.3 to 60 weight percent of one or more actives from the group of fatty acid synthetase inhibitors, wholly or partly microencapsulated,
b) 5 to 60 weight percent of organic solvents or solvent mixtures,
c) 10 to 60 weight percent of water,
d) 2 to 30 weight percent of one or more aromatic or nonaromatic surfactants,
e) 0.5 to 30 weight percent of one or more dispersants for physical stabilization,
f) 0 to 30 weight percent of further agrochemical actives, and
g) 0 to 30 weight percent of further formulating auxiliaries.

5. The method as claimed in claim 4, the formulation containing
a) 0.3 to 60 weight percent of one or more actives from the group of fatty acid synthetase inhibitors, wholly or partly microencapsulated,
b) 10 to 60 weight percent of organic solvents or solvent mixtures,
c) 20 to 50 weight percent of water,
d) 2 to 20 weight percent of one or more aromatic or nonaromatic surfactants,
e) 0.5 to 20 weight percent of one or more dispersants for physical stabilization,
f) 0 to 20 weight percent of further agrochemical actives, and
g) 2 to 20 weight percent of further formulating auxiliaries.

6. The method as claimed in claim 1, wherein the agrochemical active is an ACCase inhibitor.

7. The method as claimed in claim 1, wherein the agrochemical active is an active from the group of phenoxyphenoxy- and (heteroaryloxyphenoxy)-alkanecarboxylic acids and their esters and salts, cyclohexanedione oximes, and ketoenols.

8. The method as claimed in claim 7, wherein the agrochemical active is selected from the group consisting of fenoxaprop-P-ethyl, fenoxaprop-ethyl, diclofop-methyl, diclofop-P-methyl, clodinafop-propargyl, cyhalofop-butyl, fluazifop-P-butyl, haloxyfop, haloxyfop esters, haloxyfop-P, haloxyfop-P esters, metamifop, propaquizafop, quizalofop, quizalofop esters, quizalofop-P, quizalofop-P esters, cycloxydim, clethodim, butroxydim, alloxydim, profoxydim, sethoxydim, tepraloxydim, tralkoxydim and pinoxaden.

9. The method as claimed in claim 2, wherein one or more solvents from the group consisting of aliphatic and aromatic hydrocarbons, halogenated aliphatic and aromatic hydrocarbons, monobasic and polybasic esters, alkylene glycol monoalkyl and dialkyl ethers, cyclohexanone, isophorone, oils of natural origin, and their transesterification products are used.

10. The method as claimed in claim 2, wherein one or more surfactants from the group consisting of sulfosuccinate-based surfactants and nonionic surfactants and also mixtures of nonionic surfactants and of sulfosuccinate-based surfactants are used.

11. The method as claimed in claim 2, wherein one or more dispersants from the group consisting of polyvinyl alcohols, polyalkylene oxides, condensation products of formaldehyde with naphthalenesulfonic acids and/or phenols, polyacrylates, copolymers of maleic anhydride with alkylene alkyl ethers, ligninsulfonates, and polyvinylpyrrolidones are used.

12. The method as claimed in claims 2, wherein the microcapsules have a d(90) particle size of below 50 μm.

13. The method as claimed in claim 1, wherein the agrochemical active is applied in the form of a controlled-release formulation to the plants, parts of plants, their seed or the cultivation area.

14. The method as claimed in claim 1, wherein the agrochemical active is applied in a controlled-release formulation to the plants, parts of plants, their seed or the cultivation area.
